(19) United States
(12) Patent Application Publication
(10) Pub. No.: US 2003/0024074 A1
(43) Pub. Date: Feb. 6, 2003

(54) Biconcave connector for tubular assemblies and tool handles

(76) Inventor: Paul H. Hartman, Chardon, OH (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/209,848

(22) Filed: Aug. 1, 2002

Related U.S. Application Data
(60) Provisional application No. 60/309,358, filed on Aug. 1, 2001.

(51) Int. Cl. B62B 1/00

(52) U.S. Cl. 16/436

(57) ABSTRACT

The present invention provides a handle with a biconcave-shaped cross-section that is suitable for a hand tool, a hand tool extension, a tool connector, a wheelbarrow handle, or any of a variety of devices that are to be gripped by the human hand. The biconcave-shaped handle of the present invention conforms to the contours of the human hand to provide a more ergonomic and comfortable handle for a wide variety of applications. The biconcave shape may also be used for connecting tubular members to assemble various structures such as a dome.

This application claims the benefit under 35 U.S.C. §119(e) of the co-pending provisional application of Serial No. 60/309,358 entitled “Biconcave Connector For Tubular Assemblies And Tool Handles” filed on Aug. 1, 2001, which is incorporated herein by reference.

### FIELD OF THE INVENTION

The present invention relates generally to the field of tubular or rounded assemblies and more specifically to ergonomically designed assemblies useful as handles for a wide variety of objects, such as hand tools and other implements such as wheelbarrows, sports equipment, and as connectors between tubular members.

### BACKGROUND OF THE INVENTION

Many tools used today are hand tools. Some hand tools have a handle as an integral part of the tool. The handle provides the user with a way of manipulating and controlling the tool, and often provides a mechanical advantage as in the case of an axe, shovel, etc. Most of the hand tools used today were not designed with either ergonomics or user comfort in mind.

Because most tools are not ergonomically designed, many people find that the repetitive motions performed with an uncomfortable tool handle result in blisters, premature fatigue, and possibly a repetitive motion disorder such as “carpal tunnel syndrome.” People could work more efficiently, safely, and comfortably with tools that are designed to conform to the natural curves of the human hand.

Additionally, many handles are round in cross-section. Round tool handles require additional effort on the part of the user to offset any rotational forces. For example, a snow shovel with a round handle will tend to rotate if the weight of the snow is not evenly distributed across the shovel. The effort expended to prevent such rotation also causes premature muscle fatigue.

Traditional round handles have easily allowed for screwed connections to tools as the most expeditious way to reversibly attach the tool to the handle. As use of a tool always involves torque on the tool, tools invariably unscrew off the handle during use. Two common examples of this are paint roller extension handles and push brooms. Although the round configuration for a tubular handle is the most efficient use of materials, a non-rotating connection that could be easily detached is an often perceived, but as yet unsatisfied, need.

Therefore, a need exists in the art for a new type of handle to alleviate the above-mentioned problems inherent in tool handles.

### SUMMARY OF THE PRESENT INVENTION

A preferred embodiment of the present invention provides a tool handle comprising a member having a body with a distal and a proximal end with at least one of the ends having a biconcave-shaped cross-section. The biconcave-shaped handle of the present invention more nearly approximates the recess formed by the human hand when gripping an elongated object than do standard tool handles. Such a shape provides a more ergonomic handle that is useful for a wide variety of tool handles and for other elongated tubular objects gripped by human hands.

The biconcave-shaped handle of the present invention has numerous applications. Improvements can be attained in hand tools such as hammers, screwdrivers, axes, shovels, hoes, rakes, paint brushes and chisels by making the handles more ergonomic. Similar improvements may be seen with a variety of exercise and sports equipment having biconcave-shaped handles. Biconcave-shaped handles may also yield improvements in other implements such as wheelbarrows, lawn mowers, dollies, pushcarts, and baby strollers.

The biconcave-shaped handle or handle extension tube of the present invention confers rotational resistance to the tool and rigidity to the connection of the handle and tool. Those attributes can be useful in tools such as paint rollers, push brooms, pool skimmers, and long extension poles for tools such as tree loppers, roof rakes, and electrical transmission wire handling equipment.

Dome structures, such as geodesic domes, may be built from tubular components having biconcave-shaped ends, with connections made by using connectors inserted into converging, adjacent tubular components. Composite bicycle frames may also be assembled from tubular components having biconcave-shaped ends and joined as described herein below for domed structures.

Because the biconcave-shaped handle of the present invention provides a more ergonomic shape and naturally resists rotational motion, it can afford the user with a much greater level of control over the tool, and reduce the amount of effort directed to stabilizing the tool. Those and other advantages and benefits will be apparent from the Detailed Description of the Invention herein below.

### BRIEF DESCRIPTION OF THE DRAWINGS

The present invention will now be described for purposes of illustration and not limitation in conjunction with the following figures, wherein:

FIG. 1 is an isometric drawing of an embodiment of the present invention in the context of a paint roller extension handle;

FIG. 2 illustrates the connection between a paint roller assembly and the extension handle of FIG. 1;

FIG. 3 is a view taken along line III of FIG. 2, showing a cross-section of a paint roller assembly engaging an extension handle of the present invention;

FIG. 4 is a view taken along line IV of FIG. 1, showing a cross-section of an extension handle and a molded, cushioned handle of the present invention;

FIG. 5 is an isometric drawing of an embodiment of the present invention in the context of handles on a wheelbarrow;

FIG. 6 illustrates the underside of a wheelbarrow incorporating handles of the present invention;

FIG. 7 is a view taken along line VII of FIG. 6, showing a cross-section of a wheelbarrow handle of the present invention;

FIG. 8 is an isometric drawing of an embodiment of the present invention depicting a preferred hand position for grasping the wheelbarrow handle of the present invention;

FIG. 9 illustrates a block used to seal the end of a handle of the present invention;

FIG. 10 is an isometric drawing of an embodiment of the present invention in the context of a removable tool handle which is part of a gardening tool system;

FIG. 11 depicts one method of storage of the gardening tool system which utilizes the tool handle of FIG. 10;

FIG. 12 is an isometric drawing of an embodiment of the present invention in the context of a tennis racket handle;

FIG. 13 is a view taken along line XIII of FIG. 12 showing a cross-section of a tennis racket handle of the present invention;

FIG. 14 is an isometric drawing of an embodiment of the present invention in the context of molded handle for sports equipment;

FIG. 15 depicts on method of connecting the embodiment of FIG. 14 to a tubular extension;

FIG. 16 is a view taken along line XVI of FIG. 14 showing an outline of a molded handle of the present invention;

FIG. 17 is an isometric drawing of an embodiment of the present invention in the context of a connection between two tubular members;

FIG. 18 is a cut-away side view of the embodiment of FIG. 17;

FIG. 19 illustrates an embodiment of the present invention in the context of tubular components for a geodesic dome structure;

FIG. 20 is an enlarged view of the biconcave-shaped ends of the tubular components of the embodiment of FIG. 19 mating with V-shaped members;

FIG. 21 depicts the outer vertex piece and inner vertex piece of the embodiment of FIG. 19; and

FIG. 22 depicts the insertion of V-shaped members into the biconcave tubular components of the embodiment of FIG. 19.

### DETAILED DESCRIPTION OF THE INVENTION

The terms distal and proximal will be used herein to describe various embodiments of the present invention. The term distal refers to that end or portion of the tool or handle that is farthest away from the user grasping or operating it. The term proximal as used herein refers to that end or portion of the tool or handle that is closest to the user grasping or operating it.

All handles of the present invention may preferably be produced from a fiberglass-reinforced thermosetting polymeric resin composite by using a process known as selective interval pulshaping which is described in U.S. Pat. Nos. 5,556,496 and 5,716,487 both granted to Sumerak, the entire contents of which are herein incorporated by reference. The pulshaping process disclosed in the Sumerak patents provides a relatively simple way of producing fiberglass-reinforced thermoset plastic biconcave-shaped handles of the present invention.

Another material that may be used in fashioning biconcave-shaped handles of the present invention is a thermoplastic extruded material, preferably with biconcave-shaped ends produced by a post-extrusion thermoforming process. The inventor also contemplates using aluminum round extrusion, formed into biconcave-shaped ends preferably by using a die and mandrel stamping process, in various embodiments of the present invention. It will be obvious to one skilled in the art that the handle of the present invention may be either solid or hollow.

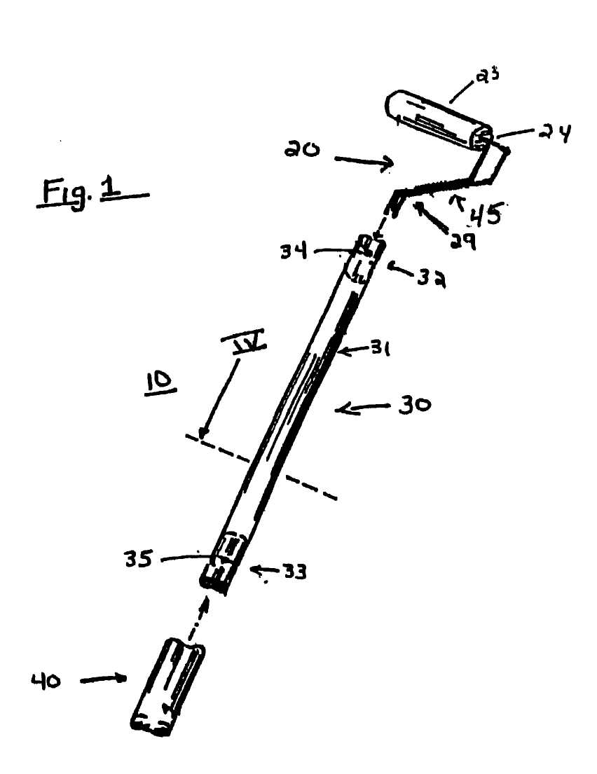

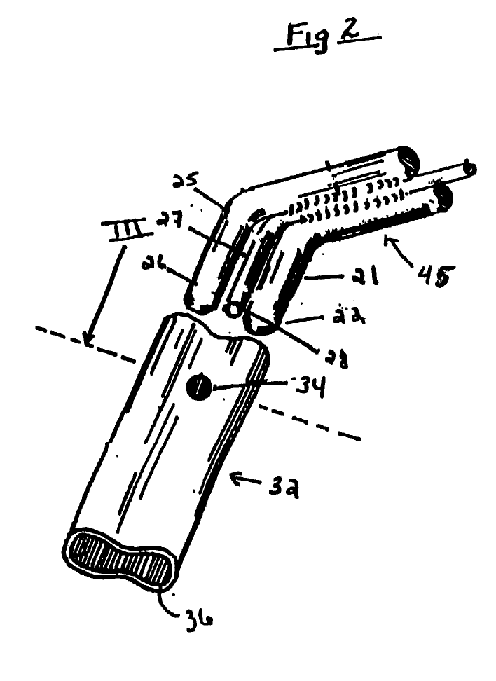

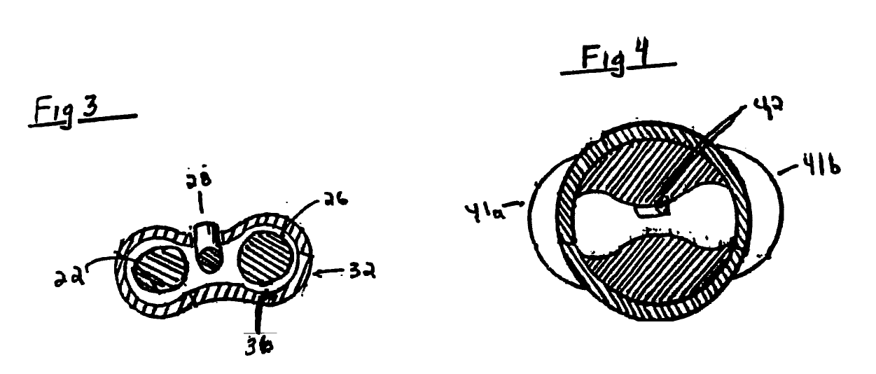

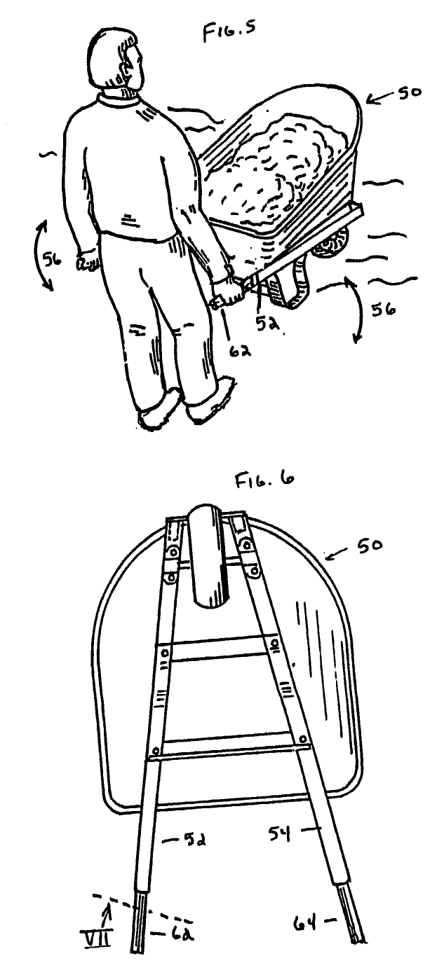

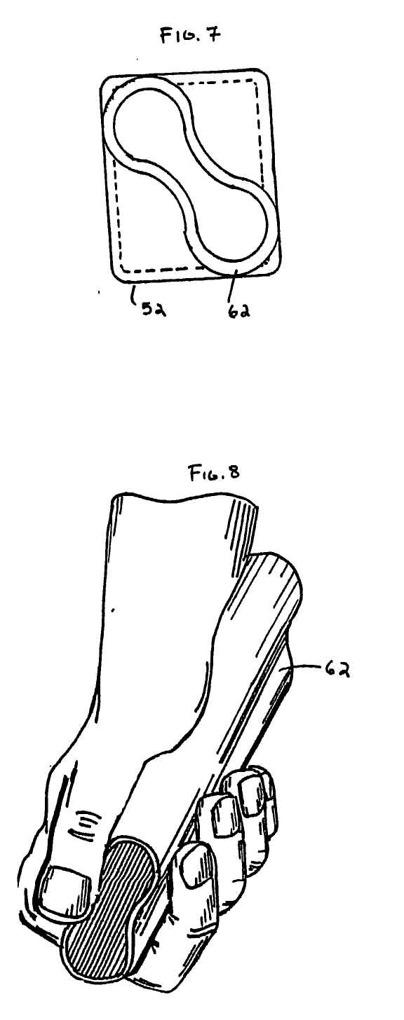

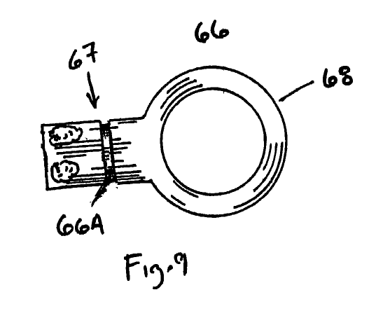

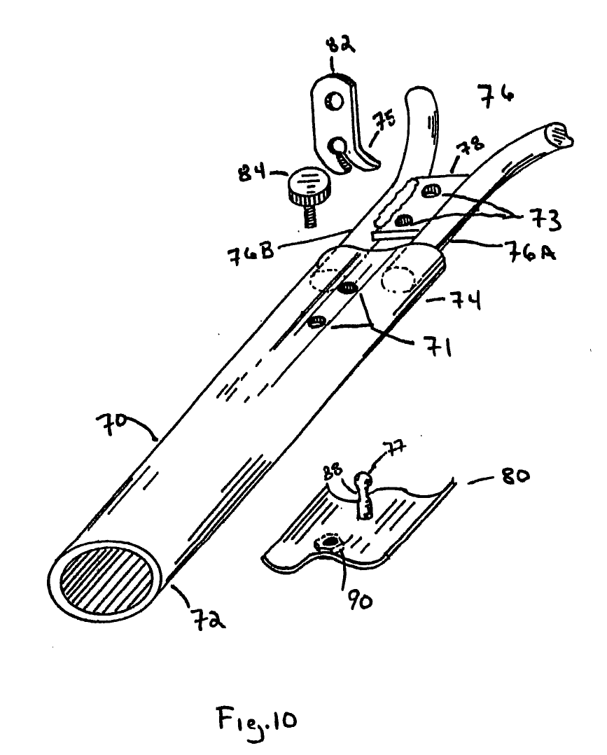

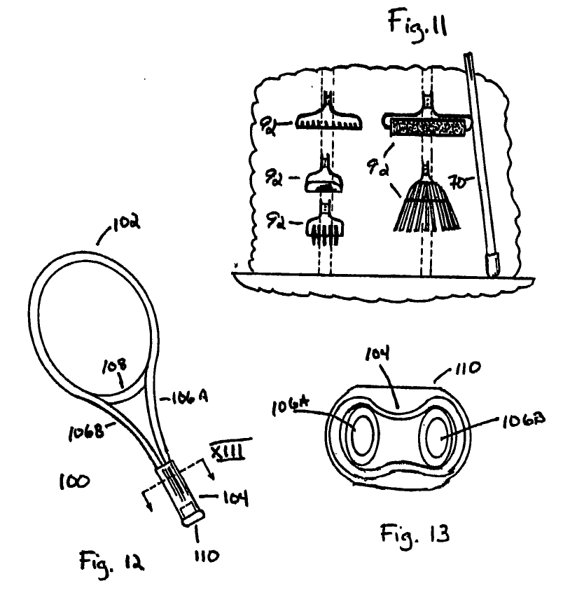

FIGS. 1 through 4 depict a first embodiment of the present invention for use as an extension handle 30 in a paint roller system 10. The depicted embodiment prevents the loosening of the handle from the paint roller assembly 20 by enforcing a directional shape to the connection that resists rotational motion of the paintbrush.

FIG. 1 shows a paint roller system 10 comprising paint roller assembly 20, extension handle 30 and molded handle 40. Dash-dot arrows illustrate how the user may assemble the paint roller system 10 in preparation for painting a ceiling or other difficult to reach surface.

Extension handle 30 preferably can have a tubular, or a round, cross-section throughout body 31, which may be the greater part of the length of the extension handle 30. At the distal, roller-holding, end 32, and at the proximal end 33, the extension handle 30 is preferably formed into a biconcave cross-sectional shape, preferably with about the same cross-sectional area as the round cross-sectional portion of body 31. Openings 34 and 35 may preferably be in the biconcave-shaped sections 32 and 33, respectively.

As shown in FIGS. 1 and 2, the paint roller assembly 20 may be comprised of three steel rods. Outer rod 21 may have an end 22 sized for insertion into the interior 36 of the distal biconcave-shaped end 32 of extension handle 30. Outer rod 21 may be bent at an angle at a point 29 so as to place the center of the roller 23 at about the midline of the extension handle 30 and may be bent two more times to become a spindle 24 of paint roller assembly 20. Similarly, a rod 25 may have an end 26 sized for insertion into the interior 36 of the distal biconcave-shaped end 32 of extension handle 30 and may be attached to rod 21 adjacent to the point where outer rod 21 becomes spindle 24 of paint roller assembly 20.

In the angled portion 45 of paint roller assembly 20, a third, thinner rod 27 may be attached to rods 21 and 25. Rod 27 may preferably be bonded to rods 21 and 25 only in the angled portion 45 of paint roller assembly 20 as is shown in FIG. 2. Rod 27 may be bent transversely at end 28 as shown in FIG. 3. On insertion of rod ends 22, 26 and 28 into interior 36 of the distal biconcave-shaped end 32 of extension handle 30, end 28 of rod 27 engages opening 34 to secure paint roller assembly 20 within extension handle 30. The user may remove the paint roller assembly 20 from extension handle 30 by pressing on end 28 of rod 27 to release end 28 from engagement with opening 34 in the distal biconcave-shaped end 32 of extension handle 30 and withdrawing rod ends 22, 26 and 28 from the distal biconcave-shaped end 32 of extension handle 30.

In another embodiment, a molded handle 40 may be provided with an interior contour similar to the exterior contour of the proximal biconcave-shaped end 33 of extension handle 30 as shown in FIG. 1. As depicted in FIG. 4, a small nib 42 may be molded on the inner surface of molded handle 40 to engage opening 35 upon insertion of the proximal biconcave-shaped end 33 of extension handle 30 into molded handle 40. As thus assembled, nib 42 prevents slippage of the handle. Additionally, the biconcave-shaped handle gives a painter a greater degree of control over the paint roller than does a round handle.

As illustrated in FIG. 4, cushions 41a and 41b may be provided on molded handle 40 to afford an even more convenient, ergonomic surface for grasping the tool handle 40 than the biconcave-shaped handle alone does. Cushions 41a and 41b may preferably be produced from a medium-hard urethane elastomer by using an injection molding process.

Materials contemplated by the inventor for fashioning the biconcave-shaped handles of the present invention include, but are not limited to, plastics, fiberglass-reinforced thermosetting resin composites, wood, graphite, and metals such as aluminum. Additionally, another connection means useful for an extension handle and a paint roller handle is illustrated in FIGS. 17 and 18.

Another embodiment of the present invention for use as the handles of a wheelbarrow is depicted in FIGS. 5 through 8. The attached Appendix, which is hereby incorporated by reference in its entirety, contains calculations for the wheelbarrow handle. As can be seen from reference to the calculations in the Appendix, the cross-sectional area of the rectangular wheelbarrow handle profile has been approximately matched to the cross-sectional area of the biconcave gripping surface. This permits reshaping of the handle without addition or removal of material from the part during the preferred pulshaping process. The depicted embodiment provides an improved grip on the wheelbarrow for the user that can reduce muscle strain and wear on the hand resulting from moving a heavy load over an uneven grade and from tipping over the wheelbarrow.

FIG. 5 shows a user moving wheelbarrow 50, supporting the load by grasping left (not shown) and right 52 supports having biconcave-shaped handles. FIG. 6 depicts the underside of the wheelbarrow showing a clearer view of the biconcave-shaped handles 62 and 64 used for grasping and lifting the wheelbarrow. FIG. 7 illustrates a cross-sectional view taken at line VII of FIG. 6 through biconcave-shaped handle 62.

As can be appreciated from reference to FIG. 8, the lower surface of the biconcave-shaped handle of the present invention serves as a gripping point for the ends of fingers. One ergonomically favorable position of the hand is depicted in FIG. 8, wherein the base of the thumb rests on the upper surface of the biconcave-shaped handle 62 of the present invention.

As can be seen in FIG. 5, the user must control the rocking motion (shown by arrows 56) of the wheelbarrow, on uneven or slippery ground, by resisting the rotation of the handles. For the user of wheelbarrow with conventional round handles, the muscles of the back part of the hand and forearm are strained in providing this resistance. Additionally, as the round handles rub against the skin of the hand gripping them, the rubbing motion may lead to the development of blisters on the user's hands.

As illustrated in FIG. 8, using the biconcave-shaped handle of the present invention as a gripping surface applies the force, needed to resist the rocking motion and lift the load, to those portions of the fingers closest to the knuckles and the cushioned base of the thumb, thus reducing or eliminating blister formation. Because of the position of the arm relative to the handle, less forearm muscle strain results than that experienced by the use of a conventional round handle in controlling the rocking motion.

Biconcave-shaped handles 62 and 64 of the present invention can be formed at the ends of wheelbarrow supports 52 and 54 using preferred polyester materials. Although the shape of the wheelbarrow supports 52 and 54 are depicted herein as square, it should be understood that they may take a variety of shapes including, but not limited to, biconcave, rounded, hexagonal, octagonal, etc. Although described herein for use in conjunction with a wheelbarrow, the inventor contemplates using this type of handle to improve a variety of implements such as rotary cultivators, lawn mowers, pushcarts, dollies, and baby strollers.

The open ends of biconcave-shaped handles 62 and 64 can preferably be sealed to prevent water and dirt accumulation therein. The sealing can be accomplished by a variety of methods commonly practiced in the art. For example, blocks sized and shaped to fit into the biconcave-shaped ends may be provided, the blocks inserted into the ends and fastened by means commonly used in the art, such as by gluing. The blocks may also help to reinforce the biconcave-shaped handle ends against compression resulting from the forces of the wheelbarrow load.

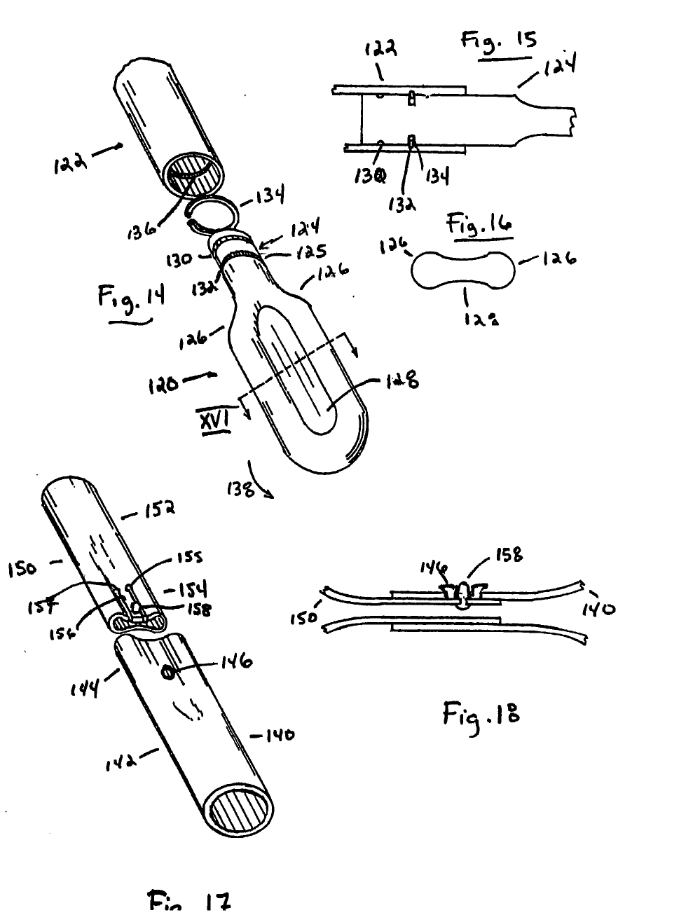

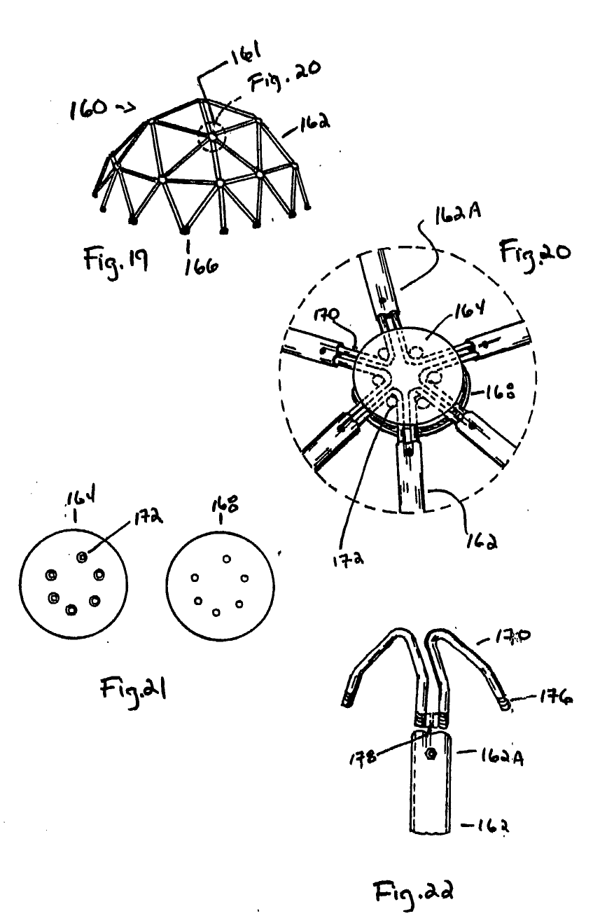

One such block 66 contemplated by the inventor is depicted in FIG. 9 with a biconcave-shaped end 67 and an eyelet 68 on one end also facilitates easy storage by allowing the wheelbarrow handles to be hung on a hook. Optional groove 66A can be cut or molded into the block 66 to provide an anchorage point to prevent pull out of the block from the biconcave handle 62 after a bonding adhesive has set between the block 66 and the handle 62. One adhesive preferred for this purpose is a thermoset bulk molding compound in which the chopped reinforcement contained therein structurally ties the block 66 to the handle in its cured state. Although the inventor prefers that the eyebolt be compression molded plastic, other suitable materials for the eyebolt include injection molded thermoplastics and cast metals.

Because the eyebolt attachment transmits forces from the eyelet 68 to the tubular portions of the handle, wheelbarrow supports 52, 54 and biconcave-shaped handles 62 and 64, this embodiment of the present invention may also be utilized in a variety of other applications wherein compressive, tensile or torsional forces are applied to a tubular component from an end fitting of a different shape or material. Such applications include, but are not limited to, torque tubes, rod end terminations, rod linkages and yoke ends, tie rods and tensioners, drive shafts for power transmission, rotational bearing couplings, ‘spider’ types of rotational couplings and stiffener assemblies that are normally accomplished through flattening and bolting of metal tubing. The ability to adhesively bond dissimilar materials provides the flexibility to add functionality in a close end fitting that is not present in the shaped tube. The use of the biconcave shape at the end of a round tubular part also facilitates economy of material use and cost in the chosen end fitting. The large surface area to volume of the biconcave portion maximizes the bond surface area for a given part.

FIGS. 10 and 11 depict still another embodiment of the present invention for use as a garden tool system comprising one handle with a biconcave-shaped end serving as a connector for the tools and a variety of gardening tools. In addition to the ergonomic benefits provided the user through the preferred biconcave shape, this embodiment of the present invention can reduce clutter in the storage of multiple tools permanently mounted to handles, can afford the user reduced costs both in duplication and replacement of handles, and can allow for a secure, removable connection to the handle. An added environmental benefit is that the use of only one handle for many tools may help reduce the use of wood resources.

As seen in FIG. 10, handle 70 consists of an elliptical portion 72 that transitions to a biconcave-shaped portion 74, which is sized and shaped to receive adapter assembly 76. Adapter assembly 76 is a common design element of the other tools of the system that may be used with the biconcave-shaped handle. These tools can include but are not limited to, shovels, trowels, squeegees, pitchforks, sidewalk edgers, small mattocks or picks, straight cultivators, rakes, brooms, and hoes.

A particularly preferred material for handle 70 is extruded aluminum tubing that is stamped to form biconcave-shaped portion 74 at the tool end. Another preferred material for handle 70 is a fiberglass-reinforced thermoset resin pultrusion produced by the selective interval pultrusion process of the Sumerak patents referred to herein.

Adapter assembly 76 consists of two rods 76A and 76B, which are bent outward and are part of the gardening tools. Rods 76A and 76B have straight portions that engage the biconcave-shaped portion 74 of handle 70. Cross plate 78 is preferably welded to both 76A and 76B and has holes 73 therethrough. Cross plate 78 helps provide a snug fit of the adapter assembly to the biconcave-shaped portion 74 and secures the tool as an anchor plate 80 is locked using a locking cam 82 and a thumbscrew 84. Adapter assembly 76, the removable tools, anchor plate 80, locking cam 82, and thumbscrew 84 can preferably be made of a metal such as steel. Both locking cam 82 and anchor plate 80 can be formed by stamping sheet steel. Post 88 and nut 90 can preferably be spot-welded to anchor plate 80.

The user attaches a tool to the handle 70 by inserting rods 76A and 76B into biconcave-shaped portion 74 and advancing the rods 76A and 76B to a point where holes 73 align with through holes 71. Post 88 is pushed through one pair of holes 71 and 73 until anchor plate 80 contacts the bottom of biconcave-shaped portion 74. Keyhole slot 75 of locking cam 82 is slid below ball 77 of post 88 as the curved portion of locking cam 82 is rotated to apply a locking force to the assembly. Thumbscrew 84 is inserted through the holes and tightened into nut 90 to lock the tool into the handle 70. The inventor prefers that the main part of handle 70 be somewhat elliptical or biconcave in shape for user comfort and transition to a biconcave portion 74 for the end adapter.

Compact storage of tools 92 on a wall is illustrated in FIG. 11. The tools may be hung on the wall by any means known to those in the art, for example by the use of nails driven into a wall stud to support the tool using holes 73 of adapter assembly 76.

FIGS. 12 and 13 illustrate another yet embodiment of the present invention in the form of a handle for a tennis racket 100. Virtually all modern tennis rackets consist of a rim portion 102 that is formed around the striking portion of the racket and connects to a handle 104 by means of extensions 106A and 106B. A bridge 108 connects the two sides of the rim portion 102 to allow stringing of the tennis racket. An end cap 110 is inserted into the back of handle 104 to create a finished product.

FIG. 13 is a cross-sectional view taken through the handle along line XIII showing extensions 106A and 106B in handle 104 which has a biconcave-shaped cross section. In the assembled product, extensions 106A and 106B are secured to handle 104 by means commonly employed in the art, such as by the use of adhesive layers applied between the two parts. A foam material, such as polyurethane foam, can also be used to fill the space between extensions 106A and 106B within handle 104.

Handle 104 can preferably be made from a composite pultrusion using an epoxy resin matrix. End cap 110 is preferably made from a vinyl-based injection molding. A variety of materials, such as epoxy graphite composites and titanium metal, can preferably be used for rim portion 102 and extensions 106A and 106B.

The biconcave-shaped handle of the present invention allows the user to easily grip the racket, in a comparable manner to that shown for the wheelbarrow handle described above, and affords a degree of directionality to the grip which may provide the user with better orientation of the face of the racket to the ball during play. Such a handle may also find use in badminton and racquetball rackets and ping-pong paddles.

FIGS. 14 through 16 show another embodiment of the present invention in the form of a molded handle 120 for use with a tubular extension 122 for sports equipment such as the handlebars of a bicycle or metal posts in a variety of exercise equipment.

As shown in FIG. 14, molded handle 120 has a cylindrical shaft portion 124 that diverges into two legs 126. The legs 126 continue as relatively straight tubular sections and converge to form a loop. The straight sections surround a concave central area 128. In an outline view taken along line XVI and shown in FIG. 16, the handle has a biconcave-shaped cross section. The cylindrical shaft portion 124 preferably can have two grooves, a shallow groove 130 and a square groove 132. A portion 125, between these two grooves 130 and 132, may preferably have a slightly smaller diameter than the other parts of the cylindrical shaft portion 124.

Tubular extension 122 can preferably have an internal diameter that is just slightly larger than the largest diameter of the cylindrical shaft portion 124. The tubular extension 122 can also preferably have an inside groove 136 that is cut into the internal diameter to accept a retaining ring 134. In the assembled system as shown in FIG. 15, the cylindrical shaft portion 124 is inserted into the tubular extension 122 with the retaining ring 134 fitting partly into square groove 132 and partly into inside groove 136. During assembly, a lubricant may preferably be applied to shallow groove 130.

Depicted in the assembly drawing of FIG. 14, the retaining ring 134 in use secures molded biconcave-shaped handle 120 in tubular extension 122 and serves as a bearing for user rotation indicated by arrow 138, of the molded biconcave-shaped handle 120 relative to the tubular extension 122. The biconcave-shaped, molded handle 120 of the present invention and the ability to rotate relative to the sports equipment afford the user a comfortable grip that can flow more naturally with the sports motion.

The molded biconcave-shaped handle 120 can preferably be produced from a composite molding compound based on polyester and fibrous reinforcements such as nylon. The retaining ring 134 can preferably be produced from polymers, such as polyvinylidene fluoride, having significant strength, natural lubricity, and chemical resistance to prevent swelling from the lubricant. The inventor contemplates that the retaining ring 134 can be elongated significantly to form a type of bushing.

FIGS. 17 and 18 illustrate another embodiment of the present invention as a connection between two tubular extension handles, a first extension handle 140 and a second extension handle 150. The second extension handle 150 consists of a round tubular portion 152, which can preferably be formed by selective interval pulshaping to a biconcave-shaped section 154. A center spring section 156 can preferably be created by making two longitudinal slits 155, 157 into one surface of the biconcave-shaped section of extension handle 150. A catch post 158 can preferably be riveted to a hole in center spring section 156 with an expanded rivet head.

First extension handle 140 consists of a straight tubular portion 142, which can preferably be formed into a biconcave-shaped socket portion 144 by means of the selective interval pulshaping process of the Sumerak patents referenced herein. Extension handle 140 can preferably have a grommet 146 inserted therein and adhesively bonded to biconcave-shaped socket portion 144. The interior perimeter of the first extension handle 140 is slightly larger than outside perimeter of the second extension handle 150 in the area of biconcave-shaped socket portion 144. When assembled, as depicted in FIG. 20, first extension handle 140 fits snugly into second extension handle 150, thereby securing the two extension handles. In the assembly process, center spring section 156 deflects as catch post 158 glides along the interior surface of first end 140 until the catch post reaches grommet 146. At that point, catch post 158 pops through grommet 146 and secures the two extension handles 140 and 150 together. When disassembly is desired, the user simply depresses catch post 158 and pulls the handles apart.

The embodiment of the invention depicted in FIGS. 17 and 18 is well suited to a variety of applications wherein twisting between parts is undesirable, such as the paint roller handle described above. Extension handles for pool skimmers, brushes and rakes for removal of snow from roofs, loppers for tree pruning and equipment for handling live electrical lines are among other potential applications contemplated by the inventor for this embodiment. In those last two applications, pneumatic or hydraulic actuators are typically used to produce a mechanical action at the distal end of an extension pole that is initiated by the user at the proximal end. One or two lengths of tubing can preferably be threaded through the extension handle(s) to connect to a variety of pneumatic or hydraulic devices such as cylinders, valves, or pumps.

FIGS. 19 through 22 show another embodiment of the present invention used in the assembly of a plurality of tubular components 162 connected at a plurality of vertices 161 to form a dome structure 160. Dome structure 160 is an octahedral breakdown dome composed of a number of tubular components of varying lengths. Tubular components 162 are shown converging on an outer vertex plate 164 in FIG. 19. A closer view of one of the vertices 161 is depicted in FIGS. 20 through 22. Each tubular component 162 preferably can have an elongated, round cross section for most of its length and be formed at both ends into a biconcave-shaped connector 162A. Each tubular component can preferably have a hole in the biconcave-shaped section thereof.

As shown in FIGS. 20 and 21, the tubular components 162 are secured to one another at vertex 161 using outer vertex plate 164, inner vertex plate 168, a series of bent, tubular, V-shaped members 170 and a series of internally threaded posts 172 that are bonded to outer vertex plate 164. Each tubular component 162 receives two tubular, V-shaped members 170. Each tubular, V-shaped member 170 comprises two straight leg portions, which comprise a first bend and a second bend. The vertex bends of the tubular V-shaped members are entrapped by the threaded posts 172 and a series of cap screws 174 which are threaded into the threaded posts 172 through openings in plate 168.

The straight leg portions of the tubular, V-shaped members 170 can be modified with a set of gripping ridges 176 and a set of welded tabs 178. Welded tabs 178 are attached to the straight leg portions so as to lie in the plane that connects the two bent, tubular, V-shaped members 170 as they are inserted into tubular components 162. The width of the welded tabs 178 and the attached straight leg portions for two bent tubular, V-shaped members 170 is slightly less than the interior diameter of any tubular component 162 taken at its widest point.

A preferred method of assembly of dome structure 160 comprises attaching the tubular components 162 to the tubular, V-shaped members starting with the vertices closest to the ground. Stanchions 166 can preferably be anchored in the subsoil to connect the dome structure 160 to grade. The outer vertex plates 164 and inner vertex plates 168 can preferably be attached by threading the cap screws 174 into the threaded posts 172, thereby firming up the row of vertices. A series of securing nuts and bolts can preferably be passed through the through openings in the biconcave-shaped connector 162A to lock the tubular components 162 to the tubular, V-shaped members 170. If welded tabs 178 are used, the straight leg portions of the tubular, V-shaped members 170 are physically prevented from pulling out of the tubular components 162 by the securing bolts. If gripping ridges 176 are used, friction is increased between the straight leg portions of V-shaped members 170 and the biconcave-shaped connectors 162A of the tubular components 162 to limit pull out. Sequential assembly of higher rows of vertices may preferably continue to complete the dome structure 160.

Many inexpensive, conventional dome structures utilize tubing that is flattened on the ends for assembly at the vertices, resulting in stress concentration at the creases in the metal and at other weak points. The present invention eliminates this problem by distributing the force transmitted to and from a vertex over a large surface area. Another drawback to the conventional flat tubing system is that it cannot be used with composite tubing. The struts of the present invention are preferably made from reinforced composite materials, with the biconcave-shaped sections formed by the selective interval pulshaping process of the Sumerak patents referenced herein. Polyester reinforced with fiberglass is a particularly preferred material because of its low cost. Epoxy reinforced with carbon can preferably be used where high strength to weight ratios or conductive properties are important.

Larger, more highly structured domes such as those used for building arenas incorporate cast adapters fitted into round tubing that comprises the metal struts of the dome. Those conventional cast adapters are typically affixed to the round tubing with rivets, thereby concentrating stress into specific areas rather than evenly distributing it. Using the biconcave-shaped struts of the present invention, the tubular, V-shaped members 170 will contact about 71% of the interior surface of the biconcave-shaped section, thereby distributing the stress in a more even manner. The securing nuts and bolts are used in this embodiment of the present invention only for clamping the tubular, V-shaped members 170 and have no load transfer function. If welded tabs 178 are used, the thickness of the welded tabs 178 can be adjusted to limit forces applied to the biconcave-shaped sections 162 by the securing nuts and bolts.

In conventional dome structures, the point where the cast adapters meet the hubs requires specific angles for specific struts, which requires costly tooling. Although the tubular, V-shaped members 170 of the present invention are specific to strut lengths and vertices, they can be readily made to specifications by using a programmable, automated tubing bender.

The assembly method utilizing the biconcave-shaped connector of the present invention is equally applicable to a variety of structures based on strut assembly and domes of all types including those with a geodesic layout. In dome structures with double shells of struts, (for example, the geodesic dome located at the American Society for Metals in Newbury, Ohio) one can preferably drill through the outer vertex plate and the inner vertex plate to accommodate posts to tie the shells together. Additional openings can preferably be drilled through the vertex plates as needed for other devices such as tension cables and lighting fixture attachments in the interior of the dome structure.

As will be apparent from the above descriptions, the biconcave shaped handles of the instant invention can be used for a wide variety of tools. The biconcave shaped handles may also be useful in a wide variety of other implements such as wheelbarrows lawn mowers, dollies, pushcarts, baby strollers, ping-pong paddles, and tennis, badminton, and racquetball rackets.

The foregoing illustrations of embodiments of the present invention are offered for purposes of illustration and not limitation. It will be readily apparent to those skilled in the art that the embodiments described herein may be modified or revised in various ways without departing from the spirit and scope of the invention.

[image]

[image]

I claim:

1. A tool handle comprising:
a member having a body with a distal end and a proximal end, at least one of said ends having a biconcave cross-section.

2. The tool handle of claim 1, wherein said handle is made of a material selected from the group consisting of plastic, fiberglass-reinforced thermosetting polymeric resin composite, pultruded fiberglass-reinforced thermosetting polymeric resin composite, metal, aluminum, extruded aluminum, graphite, and wood.

3. The tool handle of claim 1, wherein said handle is hollow.

4. The tool handle of claim 1, wherein said handle is solid.

5. The tool handle of claim 1, wherein said tool is selected from the group consisting of hammer, screwdriver, chisel, paint brush, paint roller, axe, shovel, broom, hoe, rake, trowel, squeegee, pitch fork, straight cultivator, sidewalk edger, mattock, and pick.

6. The tool handle of claim 1, wherein said handle is made by selective interval pulshaping.

7. A combination comprising:
a first member having a body with a distal end and a proximal end, at least one of said ends having a biconcave cross-section; and
a molded portion which comprises a second member with an interior shape approximating the exterior shape of said proximal end of said first member, said molded handle being sized and shaped to receive said proximal end of said first member.

8. The combination of claim 7, wherein said proximal end of said first member includes an opening therethrough.

9. The combination of claim 8, wherein said molded portion includes a nib on an interior surface thereof for structurally engaging said opening in said proximal end of said first member.

10. The combination of claim 7, wherein said molded portion includes at least one cushion on the exterior surface thereof.

11. An implement handle comprising:
a member having a body with a distal end and a proximal end, at least one of said ends having a biconcave cross-section.

12. The implement handle of claim 11, wherein said implement is a member selected from the group consisting of wheelbarrow, dolly, pushcart, lawn mower, baby stroller, rotary cultivator, tennis racket, badminton racket, racquet ball racket, and ping pong paddle.

13. A tool system comprising:
at least one tool handle comprising a member having a body with a distal end and a proximal end, at least one of said ends having a biconcave cross-section; and
at least one tool with one end thereof shaped and sized to engage said biconcave end of said tool handle.

14. The tool system of claim 13, wherein said tool is selected from the group consisting of hammer, screwdriver, chisel, paint brush, paint roller, axe, shovel, trowel, squeegee, pitch fork, sidewalk edger, mattock, pick, straight cultivator, rake, broom, and hoe.

15. A method of assembling a dome structure comprising:
a) attaching one end of a tubular member to a stanchion;
b) inserting a first leg of a V-shaped member into the free end of said tubular member and inserting the second leg of said V-shaped member into an end of second tubular member;
c) attaching said V-shaped member to an inner and an outer vertex plate;
d) repeating steps a) through c) to assemble the lower portion of said dome structure;
e) inserting a first leg of a second V-shaped member into an end of a third tubular member and inserting the second leg of said second V-shaped member into an end of a fourth tubular member;
f) attaching said second V-shaped member to an inner and an outer vertex plate; and
g) repeating steps e) and f) to assemble the remainder of said dome structure, wherein each said tubular member comprises a body with a first and second biconcave end.

16. The method of claim 15, wherein pull out of the inserted said legs is reduced by said V-shaped member including a set of gripping ridges thereon for increasing friction between said biconcave-shaped cross-sectional end and said V-shaped member.

17. The method of claim 15, wherein pull out of the inserted said legs is prevented by said V-shaped member including a set of welded tabs thereon for structure engagement with a fastener inserted in said tubular members.

18. A molded handle comprising:
a member comprising a first end having a cylindrical shaft portion and a second end having a biconcave-shaped cross section.

19. A combination comprising:
a molded handle comprising a member comprising a first end having a cylindrical shaft portion and a second end having a biconcave-shaped cross-section, the outer surface of said cylindrical shaft portion having at least one groove therein;
a retaining ring sized and shaped to engage said at least one groove; and
a hollow tubular member having a diameter slightly greater than the diameter of said cylindrical shaft portion and the inner surface of said hollow tubular member having a groove therein for structurally engaging said retaining ring.

20. The combination of claim 19, wherein said retaining ring is elongated so as to form a bushing.
